(19) United States
(12) Patent Application Publication
(10) Pub. No.: US 2009/0307206 A1
(43) Pub. Date: Dec. 10, 2009

(54) SELF VERIFYING ADDRESS UPDATE PROCESS AND SYSTEM

(75) Inventors: Philip R. Morrison, Sartell, MN (US); Gordon O. Meyer, Sartell, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: IS Technologies, LLC, Sartell, MN (US)

(21) Appl. No.: 12/133,906

(22) Filed: Jun. 5, 2008

(51) Int. Cl. G06F 7/00

(52) U.S. Cl. 707/5

(57) ABSTRACT

Address information is analyzed and ranked to provide a relative indication of the reliability of a particular address. The system and method utilized, perform modeling of address data, which produces a model that can be applied to a particular address. A resulting score is generated for each address discovered relating to a particular individual or entity. Using these scores, multiple addresses can then be ranked, to determine which address is most likely to be accurate and reliable.

### BACKGROUND OF THE INVENTION

The present invention relates to the management of address information in a database. More specifically, the present invention relates to a system and method which is capable of more efficiently managing address updates. Address update management is achieved by analyzing address information to reliably determine the most accurate address for a particular person or entity.

As can be appreciated, in today's electronic information age the maintenance of accurate and reliable information is important for many different reasons. Having the most current location or address for particular individuals or entities is of obvious importance for many different reasons. Accurate address information allows businesses to be more efficient and effective when dealing with customers, clients, prospects, partners, etc. For example, it is very beneficial and helpful to maintain marketing databases with current address data to ensure that marketing materials are appropriately delivered. Similarly, in customer service applications, where notifications or other information is to be distributed to particular customers, it is important to ensure address information is accurate. The same can be true for account maintenance, enrollment, membership, benefits, etc. As another example, in a collection situation it is obviously beneficial to know a most current address for an individual, thus providing access and the ability to further pursue collection actions. While address information is generally discussed above, it is understood that this could equally be true for “contact information” such as telephone numbers, electronic mail addresses, etc.

As can be anticipated, sometimes it is difficult to track individuals or organizations. Obviously, people move with some frequency. Similarly corporations or other entities will relocate for various reasons. Each time a move or relocation is undertaken, a new address is generated related to the particular party. In addition, certain times multiple address may exist for the same entity, or alternative addresses may exist. As appreciated by those required to maintain address information, each of these situations make it very difficult to maintain accurate address information which can be reasonably relied upon.

Several steps are typically taken to maintain accurate address information including continuous requests, and periodic update activities. For example, banking and credit card statements typically include forms which solicit address change information. Similarly, periodic updates are undertaken where specific attempts are made to contact individuals using the address information provided. Other related sources such as tax filings, or publicly available records (e.g. telephone listings etc.) may also provide a source for address information.

While publicly available or privately available databases may be monitored for address changes, one typical complication relates to the accuracy of the data. More specifically, databases may often be monitored or searched to obtain address information, which results in updated address information. This information however is only as reliable as its source, which in some cases may be questionable. In other instances, search data may be used or intended for other purposes thus creating significant issues when utilized for address update information. Further, when address searches are carried out, it is possible to obtain large volumes of information which is difficult to rank or prioritize. As this suggests, it is difficult to accurately verify address changes and address information in many circumstances.

In a typical process for maintaining address information, update databases have historically been searched to determine if update records have been included. Typically, this will provide information to the “client or customer” looking for updated address information. Unfortunately, this address information is typically provided to the “client” in this raw format. As suggested above, there is no ability to analyze or verify the accuracy of this address update data. Consequently, the possibility for errors exists. Further, the reports generated typically do not provide the ability to resolve conflicts between multiple addresses. All of these circumstances create the need for a system and process which can provide quality reliable address update information. Further, there is a need to provide a mechanism for analyzing address information and assessing the quality of the various addresses provided. In this case, quality is likely measured by the likelihood of accuracy, and the likelihood that information can be delivered to that particular address.

### SUMMARY OF INVENTION

The maintenance of accurate up-to-date address data for individuals or corporations is a very important task in today's digital society. Consequently, it is important to have address information which is up-to-date so that material can reliably be delivered to the listed addresses. Further, the ability to verify whether listed addresses are accurate is also a beneficial activity.

The system and method of the present invention allow for address verification, in a manner which provides several additional advantages. Initially, this process and system provides accurate address information which can be relied upon when attempting to contact or deliver materials to individuals or organizations of some type. Additionally, in determining the accuracy of the address information in question, a ranking is provided which includes a comparison of multiple addresses and a relative ranking suggesting the reliability of address information. This ranking also provides for a comparison or relative assessment of the individual addresses involved. Further, in performing the assessment and analyses of various addresses, and empirical score is developed related to each particular address, thus providing an “objective” scoring of each address.

To achieve the above mentioned goals, the process of the present invention involves two steps. Initially, data deemed appropriate is mined for address related information. This may include the mining of directory databases, change of address databases, or other data sources suspected of maintaining this address information. When mining data in this manner, it is expected that multiple addresses may be returned, thus providing a listing of various potential addresses for any individual or organization. In addition to the address information itself, certain related data is also retrieved for use by the process of the present invention.

After retrieving the address related information, the system of the present invention will analyze the retrieved information to assess the relative quality of each particular address. This process begins by modeling the address data, and related information. This modeling is preformed on multiple modeling variables. The result of this modeling exercise is the production of a score indicating the probability of a positive outcome for each particular address retrieved. The positive outcomes include, but are not limited to, lack of return mail from the address, or some other type of response from the address indicating the correct individual or organization has been contacted.

Based upon this modeling and appropriate calculations, scores are created for each address. Utilizing this score information, a relative ranking of the various addresses can be achieved. Based upon the information retrieved, and the scoring process, the address with the highest rank will most likely be the most current and reliable address. This high score also suggests the highest likelihood of achieving delivery of information/packages etc. when attempted. Similarly, address with a lower score or rank is less reliable and less likely to be accurate.

As can be appreciated, the ability to rank and score addresses provides valuable information for many different purposes, as outlined above. This ranking and scoring can assist in making decisions related to marketing and/or delivery attempts. Further, the ability to provide a score for various addresses gives an additional measure or indication for business to utilize while making business decisions. For example, a relative score may indicate that an address is current, but the probability of actual delivery is somewhat questionable. In this case, a business may chose not to send marketing material to this address, thus eliminating the possibility of shipping and delivery costs when not necessary.

As generally outlined above, it is an object of the present invention to provide the ability to obtain and analyze address information. It is a further objective of the present invention to provide for a ranking and relative scoring of address information once obtained. This ranking and scoring is achieved through the ability to model address data once obtained.

### BRIEF DESCRIPTION OF THE DRAWINGS

Further objects and advantages of the present invention will be seen by reviewing the following detailed description, in conjunction with the drawings in which;

FIG. 1 is a flow-chart illustrating the general process of the present invention;

FIG. 2 is a more detailed flow-chart illustrating the modeling and analysis steps of the present invention; and

FIG. 3 is a system schematic showing the various components of one embodiment.

### DETAILED DESCRIPTION OF THE INVENTION

The present invention provides for the systematic analysis and scoring of address data so as to provide useful and meaningful insight regarding its accuracy and reliability. The system and method are typically usable in situation where a search or inquiry will return multiple addresses. In this context, the scoring and analysis steps of the present invention will provide further details and meaningful information regarding the multiple addresses. This information will then allow the data user to make determinations regarding the appropriate use of the retrieved address information.

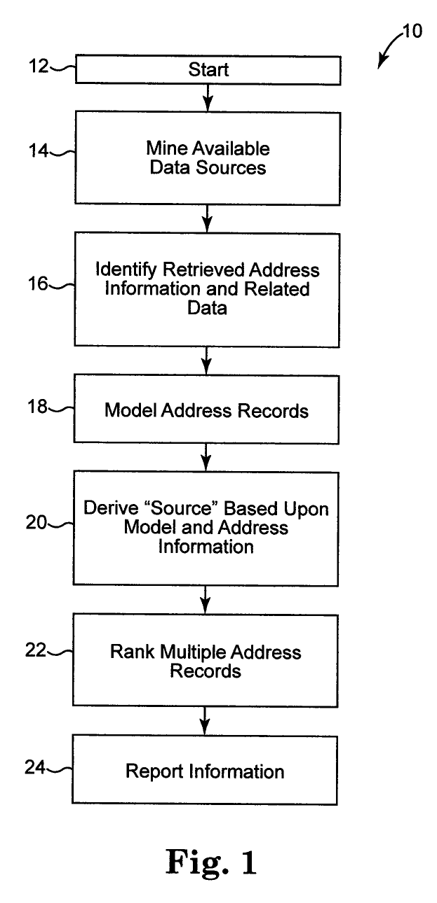

Referring now to FIG. 1 there is disclosed a flow chart illustrating the various steps of the present invention. More specifically, the address analysis process 10 is illustrated. The process begins at starting point 12 and quickly moves to the first step 14 where all desired data sources are mined to gather data used to predict the desired outcome. It is contemplated here that multiple addresses would be retrieved as a result of a single search, thus creating a scenario wherein analysis of the various addresses is difficult. Next, in step 16 the retrieved address information is identified, along with all desired related information. As recognized by those skilled in the art, the use of additional information collated with each of the retrieved addresses provides an ability to analyze and further assess the retrieved address information.

Next, at step 18 the various addresses are modeled, using all of the related information discussed above. As recognized by those skilled in the art of data modeling, several modeling techniques are available to statistically analyze the information related to retrieved address information. Specifically, the address data is correlated with related data that may suggest the reliability of the address. For example, certain databases may indicate that the address in question is a billing address for multiple credit accounts. As another example, the address in question may be correlated to valid telephone numbers. Further, the data may relate to the type of property (e.g. single family residential multi-family residential, commercial, agricultural, etc.), the structures located at the property (e.g. home, manufacturing facility, apartment complex, office building, farm buildings, etc.), or the probable use of the property (e.g. hotel, retail store, prison, etc.). This type of data, when collected in sufficient statistical quantities, can be modeled to provide certain predictions. As anticipated, the modeling will typically take place on large data sets containing prescribed information, thus providing statistical integrity to the process. This model can then be applied to the particular address retrieved and its related information to determine some type of relative score. As set forth in step 20, this process is applied to each retrieved address, and its related information to arrive at a derived score for the address. Naturally, this “score” will be somewhat arbitrary when used alone, however, can be used to provide a relative ranking when compared with other scores.

As mentioned above, the present invention is most applicable in those situations where multiple addresses are retrieved in response to a query. As such, the above derived score is determined for each particular retrieved address, and thus can later be compared with other scores for additional retrieved addresses. Based upon this derived score for each particular address, the various addresses can then be “ranked” in step 22. As anticipated, this ranking will primarily concern a simple listing of addresses in rank order based upon their score. Lastly, in step 24 a report is created.

As anticipated, based upon the process outlined in FIG. 1, the report generated in step 24 will provide relative information for the various addresses, along with their related scores. This information is obviously useful to determine which address is the most reliable and most likely to accept delivery of prescribed items. In addition, the relative ranking or score may also provide some indication of reliability for the particular address. Specifically, when standing alone, does the score exceed a particular threshold indicate that delivery of a marketing piece for example is likely to be accomplished. As such, the scoring alone, while somewhat arbitrary in nature, may provide a threshold indication suggesting a possible actions by the data user. For example, should the data user attempt shipment or delivery to a particular address.

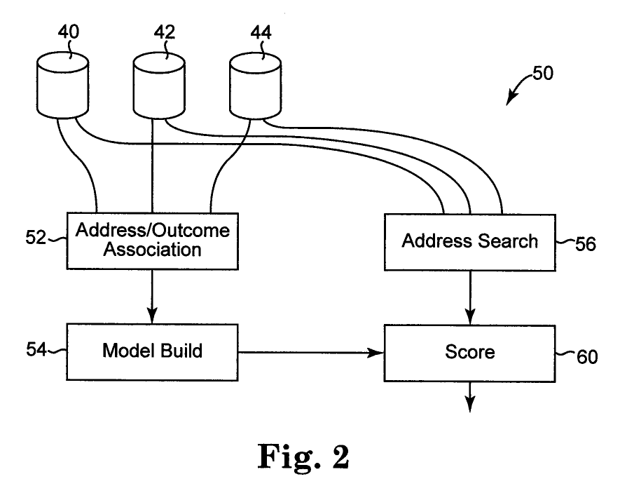

As mentioned above, the scoring of address information is based upon data modeling applied to particular databases and data sets. While various modeling techniques can be utilized, one exemplary technique is generally illustrated in FIG. 2. More specifically, modeling system 50 as schematically illustrated, includes an address/outcome association component 52 which receives information from a plurality of databases 40, 42 and 44 in order to associate known outcomes with particular addresses and related information. Using this associated information, a model build system 54 utilizes this information to generate an appropriate model. Model build system 54 will generate a model which provides the capability to predict outcomes based upon various related pieces of information.

The modeling system 50 illustrated in FIG. 2 is simply a subset of the process illustrated in FIG. 1. As such, the address search or address identification component 56 illustrated in FIG. 2 carries out the address identification step 16 discussed above. As shown, the address identification component 56 receives information from the plurality of databases 40, 42 and 44, and thus retrieves all known addresses and related information for the known addresses in question. Next, scoring system 60 utilizes the model built in the model built component 54 to generate scores, as discussed above. Once these scores are established for each discovered address, the system moves on as illustrated above to produce a ranking. This ranking is then used to establish the most reliable address.

Model build step 54, as generally discussed above, can potentially utilize several different modeling techniques. For example, this modeling may include a normal or an ordinary least squares technique, generalized linear models, neural networks, logistics, as well as Probit and Tobit model specifications. These modeling techniques provide certain examples that could be used in this process. However, additional alternatives or other possibilities may exist.

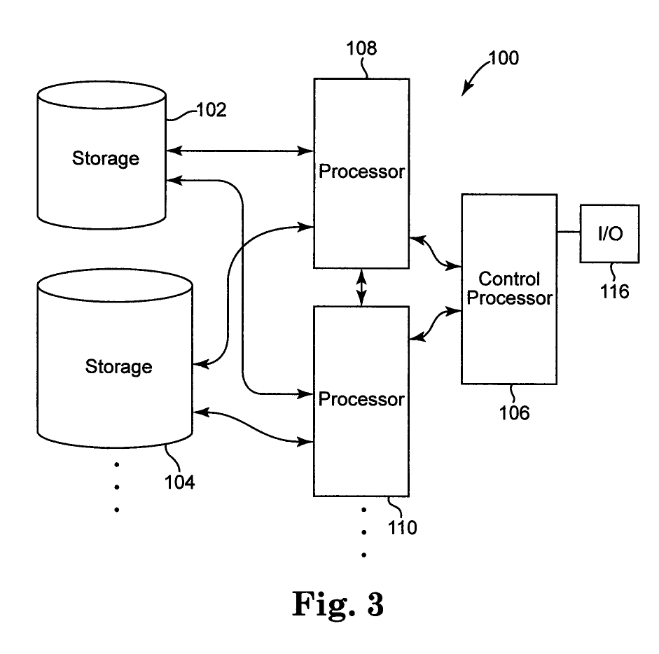

In FIG. 3, there is shown an exemplary system 100 capable of carrying out the process of the present invention. Processing system 100 (or computing system 100) includes a first storage device 102 and a second storage device 104. Each of these storage devices (first storage device 102 and second storage device 104) are capable of further, computing system 100 includes a control processor 106 which is tasked with overall control for system 100. Control processor 106 is operatively coupled to a first processor 108 and a second processor 110. Each processor is capable of carrying out multiple processing steps, as instructed and coordinated by control processor 106. First processor 108 and second processor 110 are coupled to both first storage device 102 and second storage device 104 in order to retrieve data as necessary. In this particular example, the data sets being modeled are stored in these various storage devices. The control processor 106 also includes a input/output device 116, which may include a keyboard, display screen, or combination of those components. As such, a user is able to interact with computing system 100 via input/output device 116.

As will be understood, the computing system 100 illustrated in FIG. 3 could easily include other components. In all likelihood, data storage will be distributed amongst a large number of storage devices. The various processors will have the capability to access this distributed data storage as necessary. Further, the computing system 100 will likely include more than two processors. These multiple processors are provided to allow the ability to perform processing in parallel as desired. As contemplated, the various modeling steps outlined above will likely be achieved utilizing parallel processing, which necessarily requires multiple processors within computing system 100.

Again, computing system 100 shown in FIG. 3 is merely one example. Those skilled in the art will recognize that multiple variations are possible. For example, many different storage devices could be utilized and additional processors could also be employed.

The above embodiments of the present invention have been described in considerable detail in order to illustrate their features and operation. It is clearly understood however that various modifications can be made without disparting from the scope and spirit of the present invention.

What is claimed is:

1. A method for assessing address information for an individual in order to determine a current address, comprising:
searching a plurality of databases to retrieve all available address data for the individual including each address available for the individual along with selected data related to the address information;
storing the available address information and related information;
analyzing the stored address information and related information to determine a ranking of the address information, wherein the ranking is based upon a derived score for each address available; and
storing each derived score along with the related address information so as to be accessible at a later time.

2. The method of claim 1 wherein the derived score is based upon statistical modeling of the address information and the related information and wherein the derived score is an indication of the probability that a package is deliverable to the related address.

3. The method of claim 2 wherein the related information includes credit information.

4. The method of claim 2 wherein the related information includes aggregated demographic information.

5. The method of claim 2 wherein the related information includes a physical description of a structure at each address.

6. The method of claim 2 wherein the related information includes a probable use of each address.

7. A method for validating address information for an entity based upon a plurality of data sources which include data corresponding to the address information, comprising:
mining the plurality of data sources to identify relevant address data for the entity and corresponding relevant indicator data, wherein the relevant address data includes a plurality of identified addresses for the entity;
analyzing the relevant address data and corresponding indicator data to determine a ranking score for each determined address; and
ranking the plurality of addresses for the entity based upon the determined score, wherein the ranking provides an indication regarding the relative validity of each determined address.

8. The method of claim 7 wherein the step of analyzing the relevant address data comprises a comparison of each determined address with a data model previously created based upon information contained in the plurality of data sources.

9. The method of claim 8 wherein the model is created using a least squares modeling technique.

10. The method of claim 8 further comprising storing the ranking of the plurality of addresses for purposes of validating the data model.

11. The method of claim 7 wherein the score is a relative indication regarding the probability that the determined address is reliable.

12. The method of claim 11 wherein the indicator data includes credit data for the entity.

13. The method of claim 11 wherein the indicator data includes demographic data.

14. The method of claim 11 wherein the indicator data includes a physical description of any structure at the determined address.

15. The method of claim 11 wherein the indicator data includes a probable use of property at the determined address.

16. The method of claim 11 wherein the indicator data includes a description of the property.

17. A method for assessing address information for an individual in order to determine a current address, comprising:
searching a plurality of databases to retrieve all available address data for the individual including each address available for the individual along with selected data related to the address information, wherein the searching includes searching for available related information, including credit information, demographic information, descriptions of any physical structures at the address, and a probable use of the address;
storing the available address information and related information;
analyzing the stored address information and related information to determine a ranking of the address information, wherein the ranking is based upon a derived score for each address available, wherein the derived score is based upon statistical modeling of the address information and the related information using pre-established predictive models and wherein the derived score is an indication of the probability that a package is deliverable to the related address; and
storing each derived score along with the related address information so as to be accessible at a later time.
